(19) United States
(12) Patent Application Publication
(10) Pub. No.: US 2008/0151726 A1
(43) Pub. Date: Jun. 26, 2008

(54) OPTICAL DISC RECORDING AND REPRODUCING APPARATUS AND OPTICAL DISC RECORDING AND REPRODUCING METHOD

(75) Inventors: Hideyuki YAMAKAWA, Kawasaki-Shi (JP); Koichi Otake, Yokohama-Shi (JP); Tatsuji Ashitani, Yokohama-Shi (JP); Hiroyuki Moro, Fussa-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/952,432

(22) Filed: Dec. 7, 2007

(30) Foreign Application Priority Data
Dec. 26, 2006 (JP) 2006-350275

(51) Int. Cl. G11B 7/005

(52) U.S. Cl. 369/59.22

(57) ABSTRACT

An optical disc recording and reproducing apparatus includes a maximum likelihood detection unit for decoding binary data from a reproduced multivalued signal from an optical disc, an equalization error generation unit for obtaining an equalization error signal from an input signal and an output signal to and from the maximum likelihood detection unit, a convolution processing unit for performing a convolution operation between the equalization error signal and plural values determined by the partial response class, a pattern detection unit for detecting plural predetermined data sequence patterns from the binary data output from the maximum likelihood detection unit, and a grouping and averaging processing unit for calculating a recording compensation amount for each type of the data sequence patterns by grouping convolution output signals output from the convolution processing unit in accordance with the type of the data sequence patterns and by averaging each of the grouped convolution output signals.

### CROSS-REFERENCE TO RELATED APPLICATIONS

This application claims the benefit of priority of Japanese Patent Application No. 2006-350275, filed Dec. 26, 2006, the entire contents of which are incorporated herein by reference.

### BACKGROUND

1. Field

The present invention relates to an optical disc recording and reproducing apparatus and an optical disc recording and reproducing method, and particularly to an optical disc recording and reproducing apparatus and an optical disc recording and reproducing method using a PRML method.

2. Description of the Related Art

As a method for playing an optical disc on which information is highly densely recorded, such as a HD DVD, for example, a reproduction method called a PRML (Partial Response Maximum likelihood) method is known.

The PRML method is a method of reproducing data while compressing a necessary signal band by actively using intersymbol interference (interference between reproduced signals corresponding to adjacently recorded bits), and of reproducing data on the basis of the information of the signal amplitude over a plurality of time points by effectively using the principle of intersymbol interference in accordance with a so-called maximum likelihood sequence estimation method.

In place of a conventionally used binary slice method, the PRML method is employed in the HD DVD, and so forth as a method suitable for playing a high-density recording optical disc.

Meanwhile, as a process for recording data on an optical disc, there is a process of generating an optimal recording waveform. Usually, to form one continuous recording mark on an optical disc, a recording layer of the optical disc is applied with a laser beam modulated by a recording waveform formed by a plurality of short pulse sequences. The recording waveform for forming an appropriate recording mark slightly varies according to the difference in the optical disc type and so forth. Therefore, a process is performed which generates the optimal recording waveform by correcting a standard recording waveform in accordance with the difference in the optical disc type and so forth. The above process is refereed to as a recording compensation process.

A technique capable of performing the recording compensation process also on an optical disc which employs the PRML method is disclosed in the specification of U.S. Pat. No. 7,082,566 (hereinafter referred to as Patent Document 1).

According to the technique disclosed in Patent Document 1, an index called a recording compensation amount Ec is calculated, and the optimal recording waveform is generated with the use of the index. The recording compensation amount Ec is calculated from the average value and the standard deviation of each of an error index DL which indicates that the length of a recording mark is longer than an appropriate value and an error index DS which indicates that the length of a recording mark is shorter than the appropriate value.

Although the numerical expressions of the average value and the standard deviation are simple, a circuit configuration for calculating the average value and the standard deviation from actually reproduced signals is not simple. Particularly, the process for calculating the standard deviation is complicated. Further, it is not easy to calculate the standard deviation with high accuracy.

### SUMMARY OF THE INVENTION

The present invention has been made in light of the above circumferences, and an object of the present invention is to provide an optical disc recording and reproducing apparatus and an optical disc recording and reproducing method capable of calculating, by a simple process, a recording compensation amount required to generate an optimal recording waveform in a PRML method.

To achieve the above object, an optical disc recording and reproducing apparatus according to an aspect of the present invention is an optical disc recording and reproducing apparatus using a PRML method and including a maximum likelihood detection unit, an equalization error generation unit, a convolution processing unit, a pattern detection unit, and a grouping and averaging processing unit. The maximum likelihood detection unit outputs binary data from a reproduced multivalued signal obtained by reading data recorded on an optical disc. The equalization error generation unit obtains an equalization error signal from an input signal and an output signal to and from the maximum likelihood detection unit. The convolution processing unit performs a convolution operation between the equalization error signal and a plurality of values determined by the class of a partial response according to the PRML method. The pattern detection unit detects a plurality of predetermined data sequence patterns from the binary data output from the maximum likelihood detection unit. The grouping and averaging processing unit calculates a recording compensation amount for each type of the data sequence patterns by grouping convolution output signals output from the convolution processing unit in accordance with the type of the data sequence patterns and by averaging each of the grouped convolution output signals.

Further, to achieve the above object, an optical disc recording and reproducing method according to an aspect of the present invention is an optical disc recording and reproducing method using a PRML method and including steps of: decoding, in a maximum likelihood detection unit, binary data from a reproduced multivalued signal obtained by reading data recorded on an optical disc; obtaining an equalization error signal from an input signal and an output signal to and from the maximum likelihood detection unit; performing a convolution operation between the equalization error signal and a plurality of values determined by the class of a partial response according to the PRML method; detecting a plurality of predetermined data sequence patterns from the binary data output from the maximum likelihood detection unit; and calculating a recording compensation amount for each type of the data sequence patterns by grouping output signals of the convolution operation in accordance with the type of the data sequence patterns and by averaging each of the grouped output signals.

According to the optical disc recording and reproducing apparatus and the optical disc recording and reproducing method of the above aspects of the present invention, the recording compensation amount required to generate the optimal recording waveform in the PRML method can be calculated by a simple process.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a configuration example of an optical disc recording and reproducing apparatus according to an embodiment of the present invention;

FIGS. 2A to 2C are diagrams schematically illustrating the relationship between a recording mark and a laser recording waveform for recording the recording mark;

FIGS. 3A to 3D are diagrams schematically illustrating examples of parameter adjustment of the recording waveform;

FIGS. 4A and 4B are explanatory diagrams illustrating the relationship among Y(t), St(t), Sl(t), and Ss(t) used in the calculation of a recording compensation amount Ec;

FIG. 5 is a diagram illustrating a configuration example of details of a recording compensation amount calculation unit;

FIGS. 6A to 6D are first diagrams for explaining the types of patterns used in a pattern detection unit and a recording compensation table, in which the minimum run length corresponds to a code 1;

FIG. 7 is a second diagram for explaining the types of patterns used in the pattern detection unit and the recording compensation table, in which the minimum run length corresponds to the code 1;

FIGS. 8A to 8D are first diagrams for explaining the types of patterns used in the pattern detection unit and the recording compensation table, in which the minimum run length corresponds to a code 2; and

FIG. 9 is a second diagram for explaining the types of patterns used in the pattern detection unit and the recording compensation table, in which the minimum run length corresponds to the code 2.

### DETAILED DESCRIPTION

With reference to the accompanying drawings, description will be made of an embodiment of an optical disc recording and reproducing apparatus and an optical disc recording and reproducing method according to the present invention.

### (1) CONFIGURATION OF OPTICAL DISC RECORDING AND REPRODUCING APPARATUS

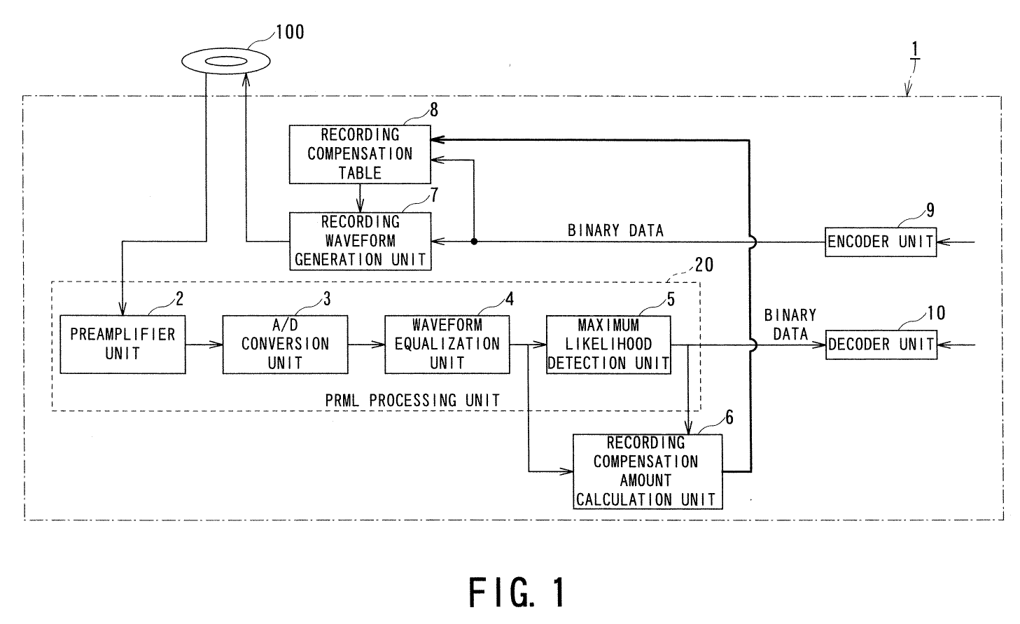

FIG. 1 is a diagram illustrating a configuration example of an optical disc recording and reproducing apparatus 1 according to an embodiment of the present invention. The optical disc recording and reproducing apparatus 1 includes, as a reproduction system, a PRML processing unit 20 for reproducing data recorded on an optical disc 100 in a PRML method and outputting the reproduced data in the form of binary data, and a decoder 10 for decoding the binary data. The output from the decoder 10 is output to external equipment, such as a personal computer (not illustrated), for example.

The optical disc recording and reproducing apparatus 1 further includes, as a recording system, a encoder 9 for modulating record data received from the external equipment such as the personal computer, and a recording waveform generation unit 7 for generating a modulated waveform of a recording laser on the basis of binary data output from the encoder 9.

The encoder 9 performs, on the record data output from the external equipment, modulation in accordance with the ETM (Eight to Twelve Modulation) rule in which the minimum run length is 1, or eight-to-sixteen modulation in which the minimum run length is 2.

From the binary data modulated by the encoder 9, the recording waveform generation unit 7 generates the recording waveform for driving the laser with recording laser power. The recording waveform is generated with reference to a recording compensation table 8.

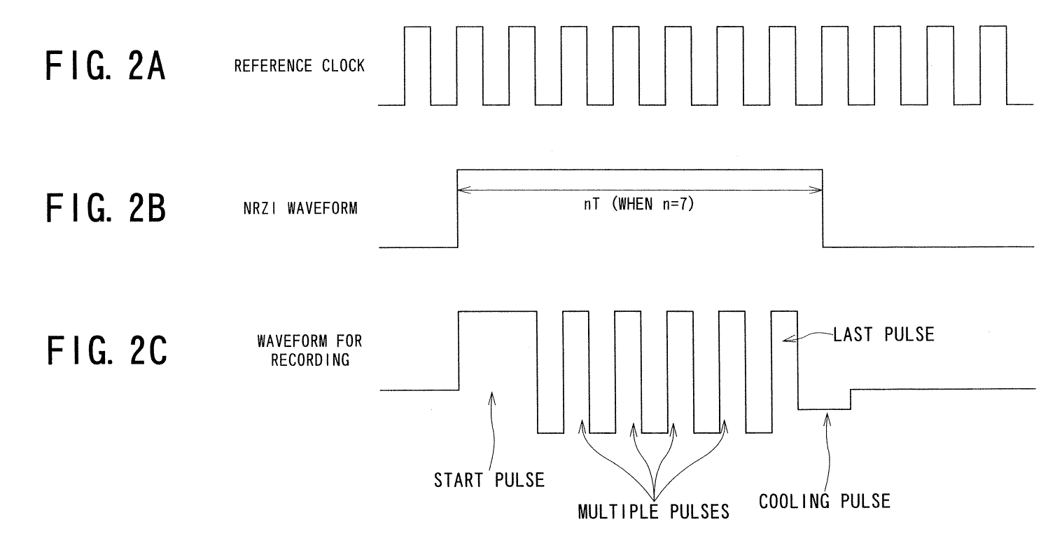

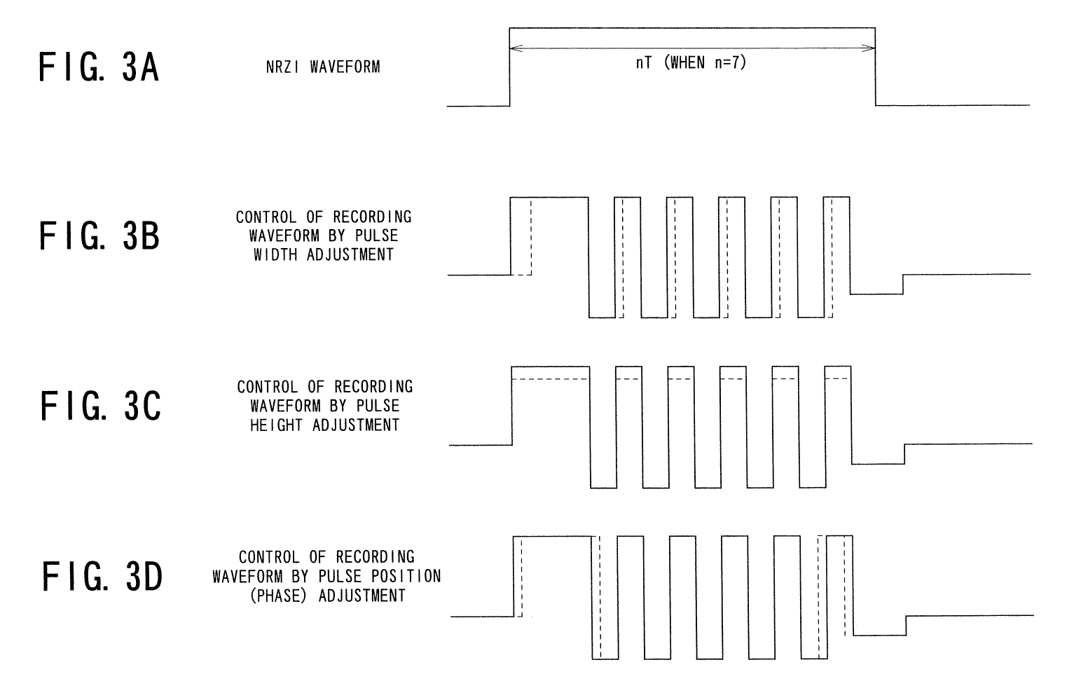

FIGS. 2A to 2C and FIGS. 3A to 3D are diagrams illustrating an outline of the generation of the recording waveform. In a recording process, a mark or a space, the length of which is the product of a cycle T of a reference clock illustrated in FIG. 2A multiplied by an integral number, is formed on the optical disc 100 as an NRZI (Non Return to Zero Invert) waveform (refer to FIG. 2B).

In this case, in the waveform output from the laser (the recording waveform), a plurality of pulse waveforms correspond to one continuous mark. For example, as illustrated in FIG. 2C, a plurality of pulses including a start pulse, a plurality of multiple pulses, a last pulse, a cooling pulse, and so forth constitute one mark.

Meanwhile, it is known that, even if the recording waveform is the same, the length of the recording mark and the shape of a rising or falling portion of the recording mark slightly vary according to the type of the optical disc 100. In some cases, therefore, if the shape of the recording waveform is incompatible with the type of the optical disc 100, a discrepancy arises between the recorded data and the reproduced data.

To cope with the above situation, a process has been conventionally performed which somewhat changes the shape of the recording waveform from a reference shape in accordance with the type of the optical disc 100 to thereby generate a recording waveform most suitable for the type of the optical disc 100 on which data is to be recorded.

FIGS. 3A to 3D are diagrams illustrating specific examples of the generation of the optimal recording waveform. For example, as illustrated in FIG. 3B, the pulse width of a reference recording waveform indicated by a solid line is adjusted as indicated by broken lines, to thereby generate the optimal recording waveform.

Alternatively, a method of adjusting the pulse height as illustrated in FIG. 3C or a method of adjusting the pulse position (phase) as illustrated in FIG. 3D may be employed.

The above parameters of the recording waveform (the pulse width, the pulse height, the pulse position, and so forth) are adjusted on the basis of an index called a recording compensation amount Ec, which will be later described. The recording compensation amount Ec is calculated by a recording compensation amount calculation unit 6 illustrated in FIG. 1.

The optimal shape of the recording waveform depends not only on the type of the optical disc 100 but also on the mark length and the space length to be recorded. Therefore, the recording compensation amount calculation unit 6 calculates the recording compensation amount Ec for each of a plurality of pattern sequences having different mark lengths and space lengths, and obtains the recording waveform corresponding to the individual recording compensation amount Ec by referring to the recording compensation table 8.

The recording compensation amount calculation unit 6 calculates the recording compensation amount Ec by using a signal output from the PRML processing unit 20. A schematic configuration and operation of the PRML processing unit 20 will be briefly described below.

The PRML processing unit 20 is configured to include a preamplifier unit 2, an A/D conversion unit 3, a waveform equalization unit 4, and a maximum likelihood detection unit 5.

A reproduced signal reproduced from the optical disc 100 is amplified by the preamplifier unit 2, and is converted into a multivalued digital signal by the A/D conversion unit 3. The reproduced multivalued signal thus digitized is subjected to a waveform equalization process by the waveform equalization unit 4 so as to produce a partial response of a predetermined class. The following description will be based on an assumption that a partial response of Class 12221 is used in the optical disc recording and reproducing apparatus 1 according to the present embodiment (a first embodiment). The reproduced multivalued signal subjected to the waveform equalization is reproduced by the maximum likelihood detection unit 5 as binary data having a binary value of “1” or “0”.

The binary data output from the maximum likelihood detection unit 5 is subjected to a demodulation process by the decoder 10. The decoder 10 performs the demodulation process based on the ETM (Eight to Twelve Modulation) rule, for example.

### (2) CONFIGURATION AND OPERATION OF RECORDING COMPENSATION AMOUNT CALCULATION UNIT

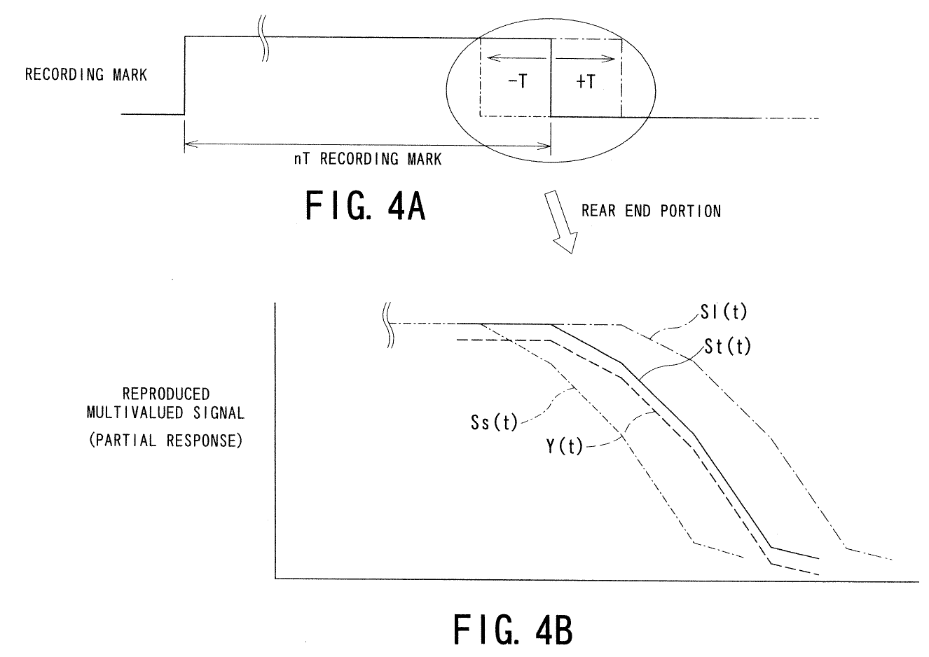

Subsequently, description will be made of a configuration of the recording compensation amount calculation unit 6 according to the present embodiment for calculating the recording compensation amount Ec, and an operation of the recording compensation amount calculation unit 6 (an optical disc recording and reproducing method). With reference to FIGS. 4A and 4B, description will be first made of the recording compensation amount Ec and the calculation formulae for calculating the amount.

FIG. 4A is a diagram illustrating a rear end portion of a recording mark having a mark length of nT (a portion in which the mark changes to a space). FIG. 4A further illustrates a recording mark whose mark length is assumed to be increased by a value T, and a recording mark whose mark length is conversely assumed to be reduced by the value T.

In FIG. 4B, a waveform Y(t), which represents the reproduced multivalued signal of the above-described recording mark, corresponds to the waveform output from the waveform equalization unit 4. The reproduced signal Y(t) (multivalued) is input to the maximum likelihood detection unit 5. Then, binary data corresponding to Y(t) is output through a Viterbi decoding process, for example. An ideal signal obtained by back calculation from the binary data (a signal calculated with an ideal partial response assumed for the binary data) is represented by the value St(t) of FIG. 4B.

Meanwhile, Sl(t) represents an ideal multivalued signal expected to be obtained from the pattern in which the mark length is increased by the value T (hereinafter referred to as the long pattern). Further, Ss(t) represents an ideal multivalued signal expected to be obtained from the pattern in which the mark length is reduced by the value T (hereinafter referred to as the short pattern).

Euclidean distances E(t), El(t), and Es(t) between the obtained reproduced signal Y(t) and the three types of ideal reproduced signal sequences St(t), Sl(t), and Ss(t) are calculated from the following equations.

Et=√Σ{Y(t)−St(t)}² (Equation 1)

El=√Σ{Y(t)−Sl(t)}² (Equation 2)

Es=√Σ{Y(t)−Ss(t)}² (Equation 3)

In the above equations, Y(t) is the amplitude of the reproduced signal obtained after the waveform equalization (an instantaneous value), St(t) is the amplitude of the ideal signal obtained from the result of maximum likelihood detection (an instantaneous value), Sl(t) is the amplitude value of the long pattern with respect to St(t) (an instantaneous value), Ss(t) is the amplitude value of the short pattern with respect to St(t) (an instantaneous value), Et is the Euclidean distance between Y(t) and St, El is the Euclidean distance between Y(t) and Sl, and Es is the Euclidean distance between Y(t) and Ss.

Further, the differences among the above Euclidean distances are defined by the following equations as a long pattern error DL and a short pattern error DS.

DL=Et−El (Equation 4)

DS=Et−Es (Equation 5)

The above differences among the Euclidean distances, i.e., the long pattern error DL and the short pattern error DS are calculated at every polarity change of a reproduced data sequence (a change from a mark “1” to a space “0” and a change from the space “0” to the mark “1”). Further, in each binary data before and after the point of the polarity change, average values μL and μS and standard deviations σL and σS are calculated for DL and DS, respectively. Then, the recording compensation amount Ec is calculated from the following equation using the above values.

Ec=(σS·μL−σL·μS)/(σL+σS) (Equation 6)

For each recording pattern before and after the point of the polarity change, Ec of Equation 6 is calculated. Then, the timing of pulse generation in the recording process is adjusted such that the equation Ec=0 is established.

The derivation of Equations 1 to 6 described above is basically disclosed in Patent Document 1.

According to the technique disclosed in Patent Document 1, the three types of ideal reproduced signal sequences St(t), Sl(t), and Ss(t) are obtained by three digital filters, respectively. Further, in three independent systems, the Euclidean distances E(t), El(t), and Es(t) are calculated for the obtained three reproduced signal sequences St(t), Sl(t), and Ss(t) (operations corresponding to Equations 1 to 3 are performed). Thereafter, the average values μL and μS and the standard deviations σL and σS are calculated for DL and DS, respectively, which are calculated by the operations of Equations 4 and 5. Thereby, the recording compensation amount Ec is ultimately calculated from Equation 6.

If the technique disclosed in Patent Document 1 is directly performed in the above-described matter, the content of the processing to be performed is complicated, and the circuit for achieving the processing is increased in size. Further, the operation of Equation 6 requires the calculation of the standard deviations σL and σS. Generally, it is not easy to calculate a standard deviation with high accuracy.

In view of the above, the optical disc recording and reproducing apparatus 1 according to the present embodiment is configured to be able to calculate the recording compensation amount Ec by a simpler process. Description will now be made of the calculation of the recording compensation amount Ec according to the present embodiment and a circuit configuration for achieving the calculation.

If it is assumed in Equation 6 that the standard deviations σL and σS of DL and DS are represented as σL=σS, Equation 6 can be modified as follows.

2·Ec=(μL−μS) (Equation 7)

In fact, the difference between the standard deviations σL and σS is approximately 10% or less. Therefore, the above assumption is not unnatural.

Further, μL and μS represent the average values of DL and DS, respectively. On the basis of Equations 4 and 5, therefore, Equation 7 can be expressed as follows.

2·Ec=Σ((Et−El)−(Et−Es))/N (Equation 8)

Accordingly, the recording compensation amount Ec is expressed as follows:

Ec=Σ(Es−El)/N (Equation 9)

Further, (Es−El) is developed into an equation expressing an instantaneous value.

(Es−El)=Σ{Y(t)−Ss(t)}²−Σ{Y(t)−Sl(t)}² (Equation 10)

Herein, ε(t) (an equalization error instantaneous value), E1(t), and E2(t) defined in the following equations are introduced.

Y(t)=St(t)+ε(t) (Equation 11)

Sl(t)=St(t)+E1(t) (Equation 12)

Ss(t)=St(t)−E2(t) (Equation 13)

With the use of ε(t), E1(t), and E2(t) described above, Equation 10 can be further modified as follows.

(Es−El)=Σ{Y(t)−(St(t)−E2(t))}²−Σ{Y(t)−(St(t)+E1(t))}²=Σ{ε(t)+E2(t)}²−Σ{ε(t)−E1(t)}² (Equation 14)

As understood from the definitional equations of E1(t) and E2(t), E1(t) and E2(t) represent the differences between ideal partial response signals. Therefore, (E2(t)+E1(t)) representing the sum of E1(t) and E2(t) is also uniquely determined by the predetermined class of the partial response. For example, if the partial response of Class 12221 is used, (E2(t)+E1(t)) can be expressed as follows.

E2(t)+E1(t)=±(1+3D+4D²+4D³+3D⁴+D⁵) (Equation 15)

In the above equation, Dⁿ is an operator representing the delay of a time n (n=1 to 5). Further, the sign “±” corresponds to the direction of the polarity change, i.e., the change from the mark “1” to the space “0” (corresponding to the change in a rear end portion of a recording mark) and the change from the space “0” to the mark “1” (corresponding to the change in a front end portion of a recording mark).

Further, the following equation is established between E2(t) and E1(t).

E2²(t)−E1²(t)=0 (Equation 16)

On the basis of Equations 16 and 15, Equation 14 can be expressed by the following convolution operation equation.

(Es−El)=2ε(t)*(E2(t)+E1(t)) (Equation 17)

In the above equation, the sign “*” represents the convolution operation.

As understood from Equation 9, the average value of (Es−El) represented by Equation 17 is ultimately the recording compensation amount Ec described above. The timing of pulse generation in the recording process is adjusted such that the value Ec is zero. Described above is the principle of the calculation of the recording compensation amount, which is the basis of the optical disc recording and reproducing apparatus 1 according to the present embodiment.

Subsequently, on the basis of Equations 15, 17 and 9, description will be made of details of the recording compensation amount calculation unit 6 which calculates the recording compensation amount Ec.

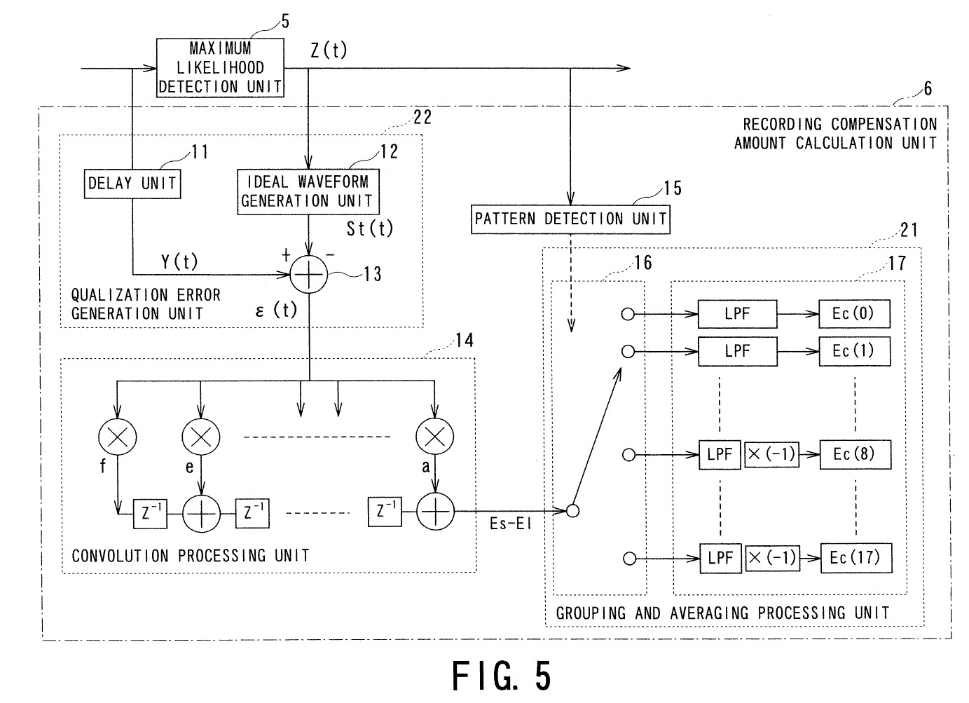

FIG. 5 is a diagram illustrating a configuration example of the details of the recording compensation amount calculation unit 6. The recording compensation amount calculation unit 6 is configured to include an equalization error generation unit 22, a convolution processing unit 14, a pattern detection unit 15, and a grouping and averaging processing unit 21.

A delay unit 11 of the equalization error generation unit 22 is a delay circuit for delaying a signal input to the maximum likelihood detection unit 5 by an appropriate time. The output from the delay unit 11 corresponds to Y(t) of Equations 1 to 3 described above. An ideal waveform generation unit 12 obtains the ideal partial response waveform St(t) from an output Z(t) output from the maximum likelihood detection unit 5. In the case of Class 12221, the ideal partial response waveform St(t) is obtained from the following equation. In the equations presented below, the time t is represented by a discrete value k.

St(k)=Z(k)+2*Z(k−1)+2*Z(k−2)+2*Z(k−3)+Z(k−4) (Equation 18)

An adder 13 is a subtractor for calculating the equalization error instantaneous value ε(t) defined in Equation 11. The adder 13 calculates the equalization error instantaneous value ε(t) from the following equation equivalent to Equation 11.

ε(k)=Y(k)−St(k) (Equation 19)

The convolution processing unit 14 performs the convolution operation on ε(t) on the basis of Equation 17 to calculate (Es−El). That is, the convolution processing unit 14 performs the operation expressed in the following equation on the equalization error instantaneous value ε(t).

(Es−El)=a·ε(k)+b·ε(k−1)+c·ε(k−2)+d·ε(k−3)+e·ε(k−4)+f·ε(k−5) (Equation 20)

Herein, in the case of Class 12221 of the partial response, the respective coefficients (a, b, c, d, e, f) are expressed as follows in accordance with Equation 15.

(a,b,c,d,e,f)=±(1,3,4,4,3,1) (Equation 21)

To simplify the configuration of the convolution processing unit 14, however, the respective coefficients used in the convolution processing unit 14 are simply expressed as follows.

(a,b,c,d,e,f)=(1,3,4,4,3,1) (Equation 22)

Further, an averaging processing unit 17 of a subsequent stage is configured to perform a process of multiplying the average value by −1. The respective coefficients used in the convolution processing unit 14 are stored as an appropriate table, for example. The content of the table is set such that equations a=1, b=3, c=4, d=4, e=3, and f=1 are established.

The grouping and averaging processing unit 21 includes a switching unit 16 and the averaging processing unit 17. When a binary data sequence output from the maximum likelihood detection unit 5 matches a later-described particular pattern, the pattern detection unit 15 controls the switching unit 16 to be connected to the averaging processing unit 17 for the individual particular pattern.

Every time the binary data sequence Z(t) matches the particular pattern, the averaging processing unit 17 selects a corresponding averaging circuit to calculate the recording compensation amount Ec, i.e., the average value of (Es−El) for the individual pattern. In this process, due to the simplification of the convolution processing unit 14 described above, the process of multiplying the average value by −1 needs to be performed in some of the patterns of the averaging processing unit 17. Each of the averaging circuits calculates the average value through a low-pass filter (LPF). The cutoff frequency used in this process is previously set to an appropriate value in accordance with the signal-to-noise ratio of the reproduced data and the occurrence frequency of each of the patterns. The calculated average value is stored in a flip-flop which can be externally referred to. In the above-described manner, the recording compensation amount Ec for each pattern can be calculated.

Subsequently, description will be made of the recording compensation table 8 and the pattern detection unit 15 of the optical disc recording and reproducing apparatus 1 according to the first embodiment.

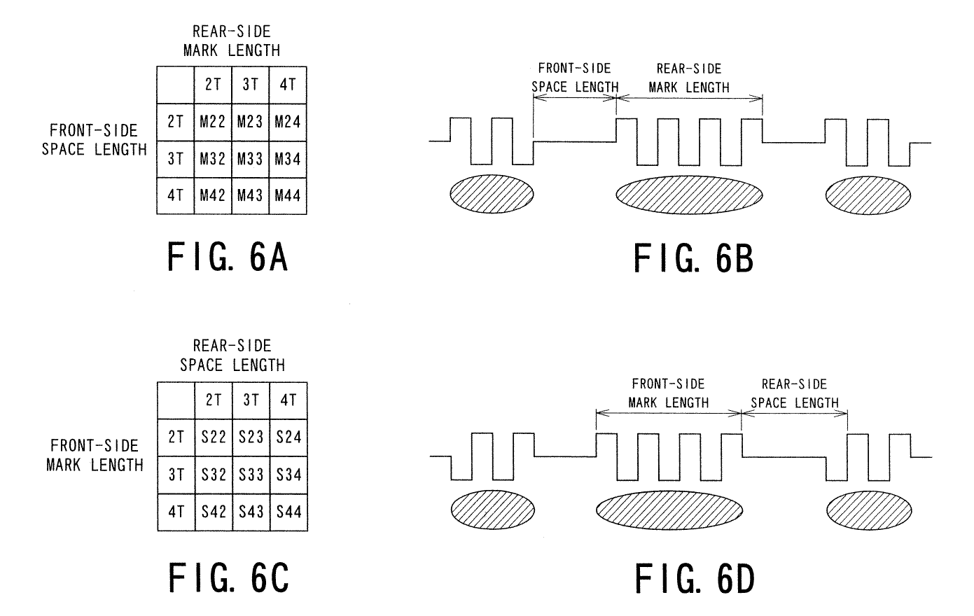

In the first embodiment, the recording waveform is controlled for each pattern in the range of 4 bits before and after the point of change of the recording polarity. A portion on the optical disc 100 having a high reflectance is referred to as a mark, while a portion on the optical disc 100 having a low reflectance is referred to as a space. The mark portion and the space portion are indicated by “1” and “0,” respectively. As described above, under the condition in which the recording is performed in accordance with the modulation rule of using the minimum run length of 1 (the minimum length of a recording mark is 2T), there are eighteen types of bit sequences crossing mark-space boundaries, as illustrated in FIGS. 6A to 6D. That is, there are nine types of patterns in which the space and the mark are located on the front side and the rear side of a boundary, respectively, and in which the front-side space continues over at least 2 bits (2T), 3 bits (3T), or 4 bits (4T) and the rear-side mark continues over at least 2 bits (2T), 3 bits (3T), or 4 bits (4T). The above patterns are represented by M22, M32, M42, M23, M33, M43, M24, M34, and M44, respectively.

Further, there are nine types of patterns in which the mark and the space are located on the front side and the rear side of a boundary, respectively, and in which the front-side mark continues over at least 2 bits (2T), 3 bits (3T), or 4 bits (4T) and the rear-side space continues over at least 2 bits (2T), 3 bits (3T), or 4 bits (4T). The above patterns are represented by S22, S32, S42, S23, S33, S43, S24, S34, and S44, respectively.

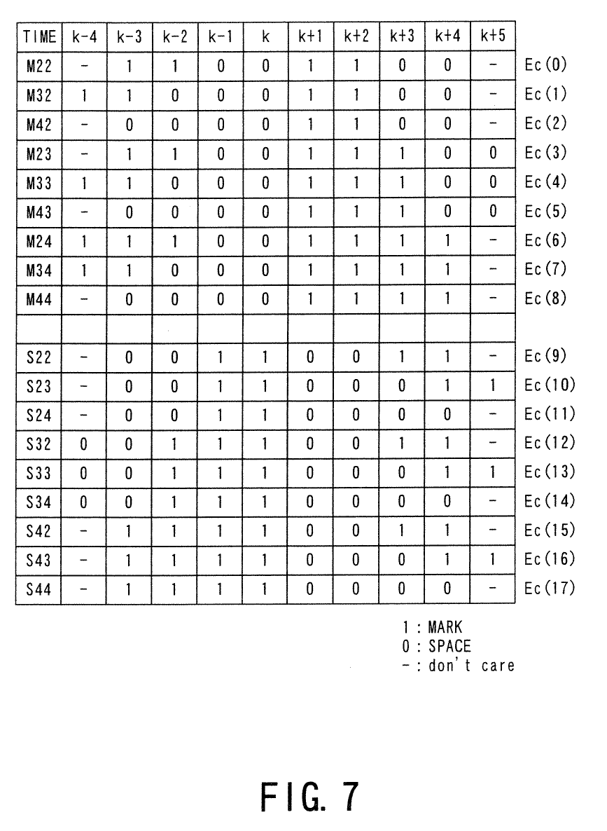

FIG. 7 is a diagram representing a total of eighteen types of patterns described above. The vertical direction of the table corresponds to the types of the respective patterns, while the horizontal direction of the table corresponds to the outputs Z(t) from the maximum likelihood detection unit 5 at times (k−4), (k−3), (k−2), (k−1), (k), (k+1), (k+2), (k+3), (k+4), and (k+5).

It is assumed, for example, that the output Z(t) from the maximum likelihood detection unit 5 is expressed as follows.

Z(t)=[−11001100−]

In this case, the pattern M22 is selected. Then, the averaging process is performed with the output (Es−El) from the convolution processing unit 14 of this case used as the input of Ec(0). The sign “−” used in the above indicates that either 1 or 0 is possible (“don't care”).

Similarly, it is assumed that the output Z(t) from the maximum likelihood detection unit 5 is expressed as follows.

Z(t)=[110001100−]

In this case, the pattern M32 is selected. Then, the averaging process is performed with the output (Es−El) from the convolution processing unit 14 of this case used as the input of Ec(1).

Further similarly, it is assumed that the output Z(t) from the maximum likelihood detection unit 5 is expressed as follows.

Z(t)=[−00110011−]

In this case, the pattern S22 is selected. Then, the averaging process is performed with the output (Es−El) from the convolution processing unit 14 of this case used as the input of Ec(9). In this case, however, the sign inversion occurs in the operation of the convolution processing unit 14. Thus, −Ec(9), which is the value obtained by multiplying the calculated average value by −1, is actually used as the output from the averaging processing unit 17. In this way, as for the patterns in which the mark is located on the front side and the space is located on the rear side, the output from the convolution processing unit 14 is inverted.

In the above-described manner, the recording compensation amount Ec for each particular pattern (a predetermined data sequence pattern) is calculated. The calculated recording compensation amount Ec is subjected to a similar process to the process described in Patent Document 1, and the content of the recording compensation table 8 is updated. With the above-described processes repeated a few times, the optimal setting of the recording compensation table 8 can be obtained.

### (3) ANOTHER EMBODIMENT

In the first embodiment, the description has been made of the case in which the minimum run length is 1 and the partial response of Class 12221 is used. The optical disc recording and reproducing apparatus according to the present invention, however, can be easily modified to an embodiment applicable to the partial response of another class.

For example, in the case in which the minimum run length is 2 and the class is 1221, Equation 15 is modified as follows.

E2(t)+E1(t)=±(1+3D+4D²+3D³+1D⁴) (Equation 23)

The above equation is obtained simply by changing the respective coefficients used in the convolution processing unit 14 such that equations a=0, b=1, c=3, d=4, e=3, and f=1 are established. Specifically, the change from Class 12221 to Class 1221 can be achieved, without a change in the configuration of the other respective units, simply by changing the content of the table storing the respective coefficients from (a=1, b=3, c=4, d=4, e=3, f=1) to (a=0, b=1, c=3, d=4, e=3, f=1).

For example, if the class of the partial response of a conventional DVD-RAM is Class 1221, and if the class of the partial response of a high-density recording HD DVD-RAM is Class 12221, the recording compensation amounts Ec of the optical discs 100 of different recording densities can be calculated without a change in the configuration (the hardware configuration and the software configuration).

Further, even if the optical disc is changed to another optical disc on which data is recorded with the minimum run length of a different code, e.g., if the first embodiment (the optical disc 100 in which the minimum run length is represented by the code 1) is changed to an optical disc 100a on which data is recorded with the minimum run length of a code 2, the recording compensation amount Ec can be calculated without a change in the configuration.

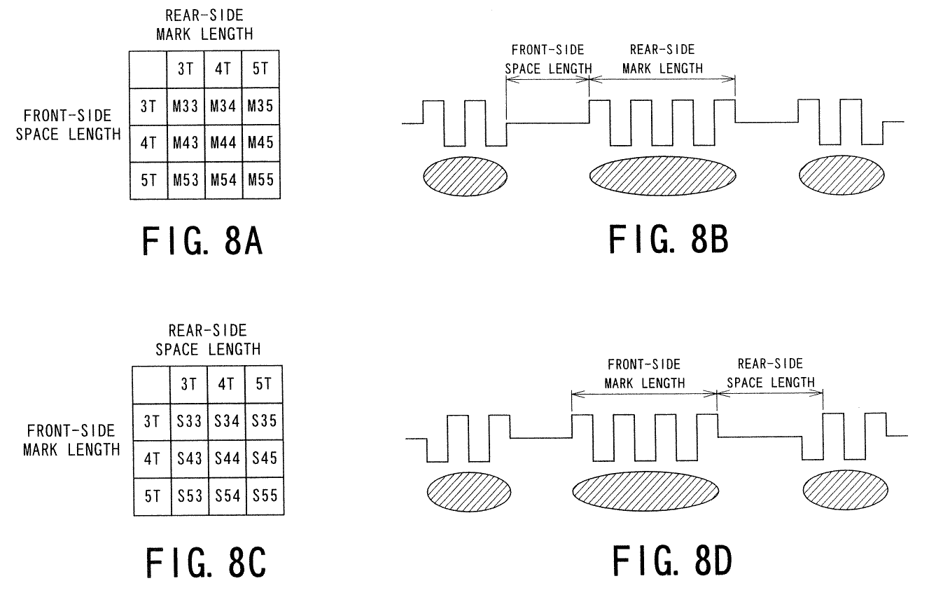

FIGS. 8A to 8D illustrate the types of patterns in accordance with the modulation rule in which the minimum run length is 2 (in this case, the minimum length of a recording mark is 3T). In the present case, too, there are eighteen types of patterns of bit sequences crossing mark-space boundaries, similarly as in FIGS. 6A to 6D. That is, there are nine types of patterns in which the space and the mark are located on the front side and the rear side of a boundary, respectively, and in which the front-side space continues over at least 3 bits (3T), 4 bits (4T), or 5 bits (5T) and the rear-side mark continues over at least 3 bits (3T), 4 bits (4T), or 5 bits (5T). In FIGS. 8A to 8D, the above patterns are represented by M33, M34, M35, M43, M44, M45, M53, M54, and M55, respectively.

Further similarly, there are nine types of patterns in which the mark and the space are located on the front side and the rear side of a boundary, respectively, and in which the front-side mark continues over at least 3 bits (3T), 4 bits (4T), or 5 bits (5T) and the rear-side space continues over at least 3 bits (3T), 4 bits (4T), or 5 bits (5T). The above patterns are represented by S33, S34, S35, S43, S44, S45, S53, S54, and S55, respectively.

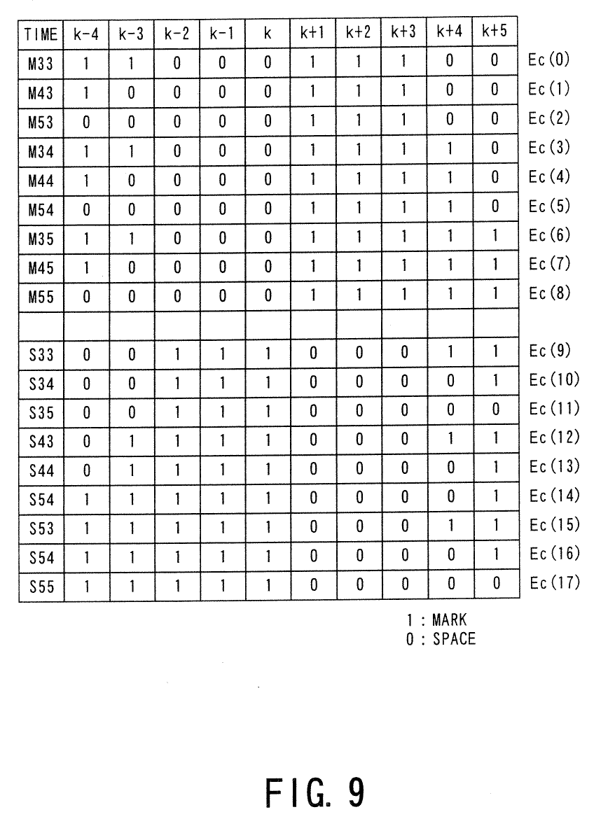

FIG. 9 is a table representing a total of eighteen types of patterns described above, similarly as in FIG. 7 (the first embodiment).

FIGS. 7 and 9 are different only in the content of the tables (the patterns of “0” and “1”), and are the same in the configuration of the tables. That is, the change of the code of the minimum run length from 1 to 2 can be achieved by changing the recording compensation table 8 from the patterns of FIG. 7 to correspond to the patterns of FIG. 9. Further, along with this change, the pattern detection performed by the pattern detection unit 15 can be changed from the detection of the patterns illustrated in FIG. 7 to the detection of the patterns illustrated in FIG. 9.

In the above-described manner, the recording compensation process can be performed by calculating the recording compensation amounts Ec of both media of a recording HD DVD (e.g., an HD DVD-RAM) having the minimum run length of 1 and a conventional recording DVD (e.g., a DVD-RAM) having the minimum run length of 2, for example, in the same circuit configuration.

As described above, according to the optical disc recording and reproducing apparatus 1 and the optical disc recording and reproducing method of the present embodiment, the recording compensation amount required to generate the optimal recording waveform in the PRML method can be calculated by a simple process. Further, the present embodiment can easily cope with the data reproduction in the partial response of different classes and the play of optical discs of different minimum run lengths.

The present invention is not directly limited to the embodiments described above. In the implementation phase, therefore, the present invention can be embodied with the constituent components thereof modified within a scope not deviating from the gist of the invention. Further, if a plurality of constituent components disclosed in the above embodiments are appropriately combined, a variety of embodiments can be devised. For example, some constituent components may be eliminated from all of the constituent components disclosed in the embodiments. Further, constituent components constituting different embodiments may be appropriately combined.

What is claimed is:

1. An optical disc recording and reproducing apparatus using a PRML method, the apparatus comprising:
a maximum likelihood detection unit for decoding binary data from a reproduced multivalued signal obtained by reading data recorded on an optical disc;
an equalization error generation unit for obtaining an equalization error signal from an input signal and an output signal to and from the maximum likelihood detection unit;
a convolution processing unit for performing a convolution operation between the equalization error signal and a plurality of values determined by the class of a partial response according to the PRML method;
a pattern detection unit for detecting a plurality of predetermined data sequence patterns from the binary data output from the maximum likelihood detection unit; and
a grouping and averaging processing unit for calculating a recording compensation amount for each type of the data sequence patterns by grouping convolution output signals output from the convolution processing unit in accordance with the type of the data sequence patterns and by averaging each of the grouped convolution output signals.

2. The optical disc recording and reproducing apparatus according to claim 1,
wherein, when the recording compensation amount is calculated for optical discs of different minimum run lengths, the recording compensation amount is calculated, without a change in the configuration of the respective units, by changing contents of a data table stored in the respective units.

3. The optical disc recording and reproducing apparatus according to claim 1,
wherein, when the recording compensation amount is calculated for optical discs of different classes of the partial response used in a reproduction process, the recording compensation amount is calculated, without a change in the configuration of the respective units, by changing contents of a data table stored in the respective units.

4. The optical disc recording and reproducing apparatus according to claim 1,
wherein, when the recording compensation amount is calculated for optical discs of different minimum run lengths and different classes of the partial response used in a reproduction process, the recording compensation amount is calculated, without a change in the configuration of the respective units, by changing contents of a data table stored in the respective units.

5. An optical disc recording and reproducing method using a PRML method, the method comprising steps of:
decoding, in a maximum likelihood detection unit, binary data from a reproduced multivalued signal obtained by reading data recorded on an optical disc;
obtaining an equalization error signal from an input signal and an output signal to and from the maximum likelihood detection unit;
performing a convolution operation between the equalization error signal and a plurality of values determined by the class of a partial response according to the PRML method;
detecting a plurality of predetermined data sequence patterns from the binary data output from the maximum likelihood detection unit; and
calculating a recording compensation amount for each type of the data sequence patterns by grouping output signals of the convolution operation in accordance with the type of the data sequence patterns and by averaging each of the grouped output signals.

6. The optical disc recording and reproducing method according to claim 5,
wherein, when the recording compensation amount is calculated for optical discs of different minimum run lengths, the recording compensation amount is calculated by changing contents of a data table used in the respective steps.

7. The optical disc recording and reproducing method according to claim 5,
wherein, when the recording compensation amount is calculated for optical discs of different classes of the partial response used in a reproduction process, the recording compensation amount is calculated by changing contents of a data table used in the respective steps.

8. The optical disc recording and reproducing method according to claim 5,
wherein, when the recording compensation amount is calculated for optical discs of different minimum run lengths and different classes of the partial response used in a reproduction process, the recording compensation amount is calculated by changing contents of a data table used in the respective steps.
